(19) United States
(12) Patent Application Publication
(10) Pub. No.: US 2014/0335626 A1
(43) Pub. Date: Nov. 13, 2014

(54) Test Bench Gas Flow Control System and Method

(71) Applicant: Randal L. Hatfield, Port Hueneme, CA (US)

(72) Inventor: Randal L. Hatfield, Port Hueneme, CA (US)

(73) Assignee: CDTI, Ventura, CA (US)

(21) Appl. No.: 13/891,758

(22) Filed: May 10, 2013

(51) Int. Cl. G01N 31/10

(52) U.S. Cl. CPC G01N 31/10
USPC 436/37; 422/83

(57) ABSTRACT

The present disclosure may include a method for preparing gas mixtures of use in testing catalysts, where the method may include using separate banks of mass flow controllers for mixing the gas composition to the desired composition and for controlling the flow of the gas composition through the heater. A separate bank may be used for controlling any suitable mix of reducing agents while another separate bank may be used for controlling any suitable mix of oxidizing gases.

### BACKGROUND

1. Field of the Disclosure

The present disclosure relates to laboratory test device and, more particularly, to a method for controlling test gas temperatures in a test bench.

2. Background Information

Catalysts may need to be tested to evaluate their performance and their response to parameter changes. Devices of use in testing catalysts may include one or more combustion engines; however, the use of these engines may be expensive, require higher maintenance than desired, and be more time consuming. Additionally, the use of these engines may not allow individual parameter variations or calibrations of use when testing catalysts. Other test devices suitable for testing catalysts may include Laboratory Scale Reactors, commonly referred to as Test Benches, and may allow a greater control over the testing conditions of the catalyst.

However, preparing a suitable variety of test gases in Laboratory-scale reactors suitable for testing a variety of samples may remain a challenge, including preparations where oxidizing and reducing materials may be mixed.

As such, there is a continuing need for improvements in test devices so as to allow a greater range of testing conditions.

### SUMMARY

The present disclosure may include a method for preparing gas mixtures of use in testing catalysts.

The method may include using separate banks of mass flow controllers for mixing the gas composition to the desired composition and for controlling the flow of the gas composition through the heater. A separate bank may be used for controlling any suitable mix of reducing agents, nitric oxide, and diluent gas; while another separate bank may be used for controlling any suitable mix of oxidizing gases, carbon dioxide, and diluent gas. The flow of gas through each bank may be controlled so as to result in any suitable gas composition, including embodiments where the amount of gas flowing through each bank may be controlled to be about half of the flow, where the amount of gas flowing through each bank may be regulated by regulating the amount of diluent gas flowing through each bank.

Embodiments where each of the banks may contribute about half of the flow may allow the events that may be generated in each of the banks to reach the catalyst sample at about the same time. In embodiments where the length of paths from the banks may differ, the ratio of the total flows for each bank may adjusted in any suitable way so as the events generated may reach the sample at about the same time. Suitable adjustments may take into account the volume of gas flowing through each branch.

Numerous other aspects, features and advantages of the present disclosure may be made apparent from the following detailed description, taken together with the drawing figures.

### BRIEF DESCRIPTION OF THE DRAWINGS

These and further features, aspects and advantages of the embodiments of the present disclosure will be apparent with regard to the following description, appended claims and accompanying drawings where:

FIG. 1 is a flow chart for testing a sample in a laboratory scale reactor.

FIG. 2 shows a diagram for a gas feed system.

FIG. 3 shows test gas generator.

It should be understood that these drawings are not necessarily to scale and they can illustrate a simplified representation of the features of the embodiments of the present disclosure.

### DETAILED DESCRIPTION

### Definitions

As used here, the following terms have the following definitions:

Mass flow controller (MFC) refers to any computer controlled analog or digital device of use in controlling the flow rate of fluids and/or gases.

Temperature controller refers to any device of use in controlling temperature in a process.

Laboratory Scale Reactor/Test Bench refers to any apparatus suitable for testing a material with a test gas.

Oxidizing agent refers to any substance that may take electrons from another substance in a redox chemical reaction.

Reducing agents refers to any substance that may give electrons to another substance in a redox chemical reaction.

Gas mixture refers to the mixture obtained from combining oxidizing agents, reducing agents, inert gases, or any other suitable gases.

Water-gas mixture refers to the mixture obtained from combining water vapor with a gas mixture.

Test Gas refers to any gas mixture of use in chemically testing an interaction between it and one or more materials.

Catalyst refers to one or more materials that may be of use in the conversion of one or more other materials.

### Description

The description of the drawings, as follows, illustrates the general principles of the present disclosure with reference to various alternatives and embodiments. The present disclosure may, however, be embodied in different forms and should not be limited to the embodiments here referred. Suitable embodiments for other applications will be apparent to those skilled in the art.

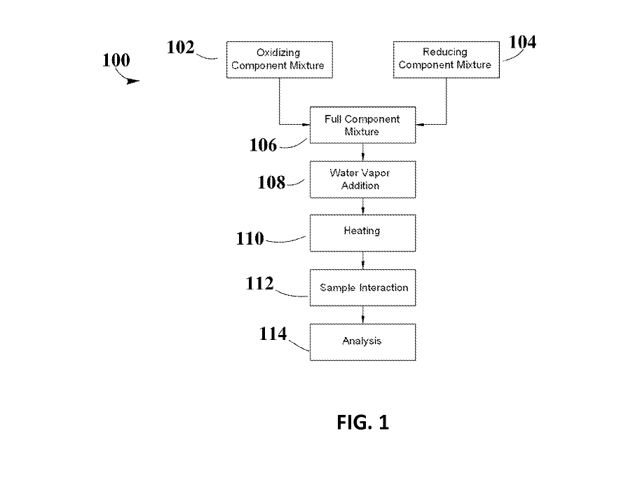

FIG. 1 is a flowchart of a method for testing a catalyst sample. Test Method 100 includes Oxidizing Component Mixture 102, Reducing Component Mixture 104, Full Component Mixture 106, Water Vapor Addition 108, Heating 110, Sample Interaction with Test Gas 112, and Analysis 114.

Test Method 100 may include mixing any number of suitable Oxidizing Components in Oxidizing Component Mixture 102. Test Method 100 may also include mixing any number of suitable reducing components in Reducing Component Mixture 104. The gas mix from Oxidizing Component Mixture 102 and the gas mix from Reducing Component Mixture 104 may then be mixed in Full Component Mixture 106, where the mixture may then undergo any suitable Water Vapor Addition 108. Test gas exiting Water Vapor Addition 108 may then undergo any suitable Heating 110, and any suitable portion of test gas having undergone Heating 110 may then undergo any suitable Sample Interaction with Test Gas 112. Any portion of test gas having undergone Sample Interaction with Test Gas 112 may then undergo any suitable Analysis 114.

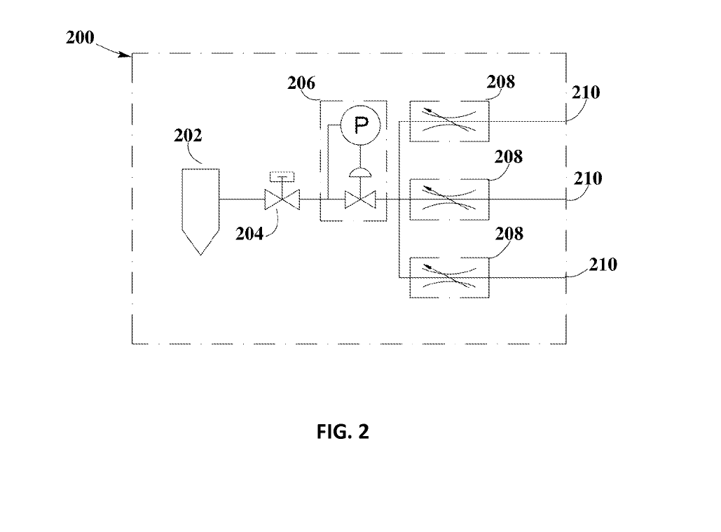

FIG. 2 shows Gas Feed System 200. Gas Feed System 200 may include Gas Source 202, Control Valve 204, Pressure Regulator 206, one or more Mass Flow Controllers 208, and one or more Output Lines 210.

Gas Source 202 may be any source suitable for delivering any suitable gas to the system, including any tank or line able to provide N2, C3H6, C3H8, H2, CO, NO, NO2, CO2, SO2 or any suitable combination thereof at any suitable concentration.

Control Valve 204 may be any valve suitable for restricting or allowing flow from Gas Source 202, including solenoid valves, hydraulic valves, pneumatic valves, or any suitable combination.

Pressure Regulator 206 may be any device suitable for regulating the pressure of gas in Gas Feed System 200, including devices including any suitable pressure gauge or pressure transducer as well as any suitable valve, including solenoid valves, hydraulic valves, pneumatic valves, or any suitable combination.

Mass Flow Controllers 208 may be any mass controller or series of mass controllers suitable for controlling the flow of gas from Gas Source 202 to one or more Output Lines 210 at a suitable frequency. Suitable Mass Flow Controllers 208 may include mass flow controllers able to provide any suitable flow rate.

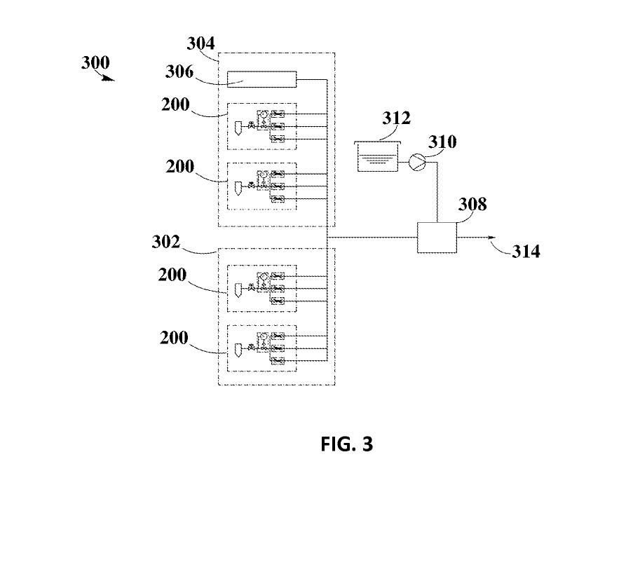

FIG. 3 shows Test Gas Generator 300, having Oxidizing Components Branch 302, Reducing Components Branch 304, Heavy Hydrocarbon Addition 306, Evaporation Block 308, Pump 310, Water Reservoir 312,

Oxidizing Components Branch 302 may include any number of suitable Gas Feed Systems 200, where the included Gas Feed Systems 200 may provide any number of oxidizing gases, dilutants, and combinations thereof, including N2, NO2, O2, and CO2.

Reducing Components Branch 304 may include any number of suitable Gas Feed Systems 200, where the included Gas Feed Systems 200 may provide any number of reducing gases, dilutants, and combinations thereof, including N2, H2, CO, NO, and any suitable hydrocarbons. Suitable Hydrocarbons may include C3H8. Suitable heavy hydrocarbons may also be added using any suitable method in Heavy Hydrocarbon Addition 306, including liquid injection and evaporation. Suitable heavy hydrocarbons may include decane, tolune, and dodecane.

The flow of the mixture of gases generated by Oxidizing Components Branch 302 and Reducing Components Branch 304 may then be preheated by any suitable means, including heated lines, where the heated lines may be heated using heat jackets. Suitable temperatures may include temperatures in the range of 130° C. to 180° C., including 150° C. The flow paths from Oxidizing Components Branch 302 and Reducing Components Branch 304 may be of any suitable length, where the flow of gas from Oxidizing Components Branch 302 and Reducing Components Branch 304 may be adjusted to be suitable so as to create the required events in Sample Interaction with Test Gas 112.

Evaporation Block 308 may be any device suitable for evaporating water and adding it to the flow of gas generated by the combination of gas flows from Oxidizing Components Branch 302 and Reducing Components Branch 304 in Test Gas Generator 300. Evaporation Block 308 may evaporate water which may be provided by one or more suitable Pumps 310, where Pump 310 may be any pump suitable for pumping water from Water Reservoir 312 to Evaporation Block 308. Suitable temperatures in Evaporation Block 308 may include temperatures in the range of 110° C. to 150° C., including 130° C.

The resulting test gas exits Test Gas Generator 300 through Output 314, where it may undergo any suitable Heating 110 before undergoing any suitable Sample Interaction with Test Gas 112 and any suitable Analysis 114.

I claim:

1. A method for the preparation of gas mixtures, comprising:
mixing at least one oxidizing component with at least one reducing component;
adding H₂O vapor to the mixture;
heating the H₂O vapor added mixture to produce a heated mixture;
providing interaction of the heated mixture with at least one sample catalyst; and
analyzing a portion of the interacted mixture.

2. The method of claim 1, wherein the heating may be from about 130° C. to about 180° C.

3. The method of claim 1, wherein the heating may be to about 150° C.

4. The method of claim 1, wherein the adding of H₂O vapor is provided by an evaporation block.

5. The method of claim 4, wherein the evaporation block may have a temperature of about 110° C. to about 150° C.

6. The method of claim 4, wherein the evaporation block may have a temperature of about 130° C.

7. The method of claim 1, wherein the at least one oxidizing component comprises at least one selected from the group consisting of N₂, H₂, O₂, CO₂, and combinations thereof.

8. The method of claim 1, wherein the at least one reducing component comprises at least one selected from the group consisting of N₂, H₂, CO, NO, C3H₈, C₁₀H₂₂, C₇H₈, CH₃(CH₂)₁₀CH₃ and combinations thereof.

9. An apparatus for the preparation of gas mixtures, comprising:
at least two gas delivery banks, each for delivering at least one of a plurality of gasses, and each comprising:
at least one gas source for receiving at least one input gas;
at least one control valve operable on the at least one input gas;
at least one pressure regulator operable on the at least one input gas;
a plurality of mass flow controllers operable on the at least one input gas; and
at least one output for outputting a mass-flow controlled, regulated one of the at least one input gas as the delivered at least one of the plurality of gasses; and
at least one evaporation block suitable for adding H₂O to a mixture of more than one of the the delivered at least one of the plurality of gasses received from a respective one of the at least two gas delivery banks;
wherein the ratio of the mixture of the more than one of the the delivered at least one of the plurality of gasses is at least partially controlled by respective ones of the plurality of mass flow controllers of ones of the at least two gas delivery banks.

10. The apparatus of claim 9, wherein the evaporation block may have a temperature of about 110° C. to about 150° C.

11. The apparatus of claim 9, wherein the evaporation block may have a temperature of about 130° C.

12. The apparatus of claim 9, wherein one of the delivered at least one of the plurality of gasses comprises at least one oxidizing component.

13. The apparatus of claim 12, wherein the at least one oxidizing component is selected form the group consisting of N₂, H₂, O₂, CO₂, and combinations thereof.

14. The apparatus of claim 9, wherein one of the delivered at least one of the plurality of gasses comprises at least one reducing component.

15. The method of claim 14, wherein the at least one reducing component is selected form the group consisting of N₂, H₂, CO, NO, C3H₈, C₁₀H₂₂, C₇H₈, CH₃(CH₂)₁₀CH₃ and combinations thereof.

16. The apparatus of claim 9, wherein the at least one control valve is selected from the group consisting of a solenoid valve, a hydraulic valve, a pneumatic valve, and any combination thereof.

17. The apparatus of claim 9, further comprising a heating element suitable for heating at least one the delivered at least one of the plurality of gasses.

18. The method of claim 17, wherein the heating may be from about 130° C. to about 180° C.

19. The method of claim 17, wherein the heating may be to about 150° C.

20. An apparatus for the preparation of gas mixtures, comprising:
a reducing component gas delivery bank for delivering at least one of a plurality of gasses, and comprising:
at least one gas source for receiving at least one reducing component gas;
at least one control valve operable on the at least one reducing component gas;
at least one pressure regulator operable on the at least one reducing component gas;
a plurality of mass flow controllers operable on the at least one reducing component gas; and
at least one output for outputting the at least one reducing component gas;
an oxidizing component gas delivery bank for delivering at least one of a plurality of gasses, and comprising:
at least one gas source for receiving at least one oxidizing component gas;
at least one control valve operable on the at least one oxidizing component gas;
at least one pressure regulator operable on the at least one oxidizing component gas;
a plurality of mass flow controllers operable on the at least one oxidizing component gas; and
at least one output for outputting the at least one oxidizing component gas;
at least one evaporation block suitable for adding H₂O to a mixture of the output at least one oxidizing component gas and the output at least one reducing component gas; and
wherein the ratio of the mixture is at least partially controlled by respective ones of the plurality of mass flow controllers.
